(19) United States
(12) Patent Application Publication
(10) Pub. No.: US 2009/0220411 A1
(43) Pub. Date: Sep. 3, 2009

(54) Method for producing activated lime for removal of acid gases from a combustion gas

(76) Inventors: Lewis B. Benson, Sewickley, PA (US); J. Casey Schulz, Crescent, PA (US)

Correspondence Address: KRATZ, QUINTOS & HANSON, LLP, Greater Beneficial Union of Pittsburgh Building, 4232 Brownsville Road Suite308, Pittsburgh, PA, 15227, US

(21) Appl. No.: 10/583,008

(22) PCT Filed: Apr. 13, 2006
(86) PCT No.: PCT/US06/13765

§ 371 Date: Mar. 24, 2009

Related U.S. Application Data
(60) Provisional application No. 60/672,834, filed on Apr. 19, 2005.

(51) Int. Cl. C04B 2/02

(52) U.S. Cl. 423/636

(57) ABSTRACT

An activated lime for use in removing acid gases from a combustion gas stream is produced by thermally decomposing calcium hydroxide to calcium oxide through contact or the calcium hydroxide with a heated gas stream at a temperature or between 750-950° F. for a time sufficient to produce a calcium oxide having a specific surface area of between 30-48 square meters per gram, and collecting the product so produced.

### BACKGROUND OF THE INVENTION

The present invention relates to a method of producing an activated calcium oxide for use in the removal of acid gases, such as sulfur trioxide vapor, sulfur dioxide, hydrogen chloride and hydrogen fluoride from combustion gases, such as those produced in industrial plants.

Hydrated lime (calcium hydroxide) has been used for capture of sulfur dioxide. For example, in U.S. Pat. No. 5,084,256 a method is described where an alkali hydrate sorbent is injected, as a dry powder, to intermediate temperature (800°-1200° F.) combustion/process gases. The hydrates are injected in a manner such that the injection does not significantly decrease the temperature of the gases and such that reaction of the sorbent with SO₂ and the combustion gases converts at least 25 percent of the sorbent to sulfite, with the remaining unreacted sorbent being alkali hydroxide.

Hydrated lime has also been used for capture of sulfuric acid or sulfur trioxide vapor. For sulfur trioxide control, hydrated lime has been injected into flue gas in a coal-fired power plant ahead of a particulate collector, usually an electrostatic precipitator (ESP). Flue gas temperature at this location is 300-350° F. Capture of SO₃ is marginally effective with normal hydrated limes. The specific surface area of normal hydrated lime ranges from 10-23 square meters per gram, and the specific surface area is unchanged upon injection at this temperature range. Specially prepared hydrated limes with higher than normal specific surface areas ranging from 25-38 square meters per gram are more effective at capturing sulfur trioxide via injection ahead of an ESP. Specially prepared hydrated limes include those prepared with additives (glycols, amines, and alcohols) and those prepared with excess water. The disadvantages of these specially prepared hydrated limes include cost of additives and cost from drying excess water from the product. Also, additives may contaminate other hydrated lime products produced in the same hydration plant and make these other products unsuitable. Although a number of patents on specially prepared hydrated limes claim substantially improved specific surface areas, none of these products are produced commercially in the United States due to the noted disadvantages.

Although it is already well-known that thermal decomposition of calcium hydroxide (to calcium oxide and water vapor) increases its reactivity with sulfur dioxide, it is not well-known that thermal decomposition may also increase reactivity with sulfur trioxide. Also, although it is well-known that calcium hydroxide is completely decomposed at 1076° F., rapid decomposition can begin at as low as 750° F. Our test data shows that partial decomposition at 750° F. yields a large increase in the number of active sites available for acid gas absorption. Moreover, test data shows that decomposition at 1076° F. yields fewer active sites than decomposition at 750° F.

One aspect of the invention is that calcium oxide is prepared from hydrated lime and is activated for acid gas capture at a much lower temperature than the complete decomposition temperature of 1076° F. for calcium hydroxide (reference, CRC Handbook of Chemistry and Physics, 53 ed., p. B-77).

### SUMMARY OF THE INVENTION

An activated lime for use in the removal of acid gases from a combustion gas stream is prepared by thermally decomposing calcium hydroxide (hydrated lime) to produce calcium oxide by contacting the calcium hydroxide with a heated gaseous stream having a temperature of between 750-950° F., for a sufficient time to produce a calcium oxide that has a specific surface area of between about 30-48 square meters per gram, and collecting the resultant calcium oxide so produced for use later in contact with a combustion gas stream to remove acid gases therefrom.

### BRIEF DESCRIPTION OF THE DRAWINGS

In the drawings;

FIG. 1 is a schematic illustration of the method of the present invention;

FIG. 2 is a schematic illustration of a preferred method of the present invention;

FIG. 3 graphically illustrates the specific surface areas versus temperature resulting from treatment of three hydrated limes;

FIG. 4 graphically illustrates the absorption of SO₂ vs. time for a hydrated lime and an activated lime;

FIG. 5 graphically illustrates the absorption of SO₂ vs. time of a further activated lime; and

FIG. 6 graphically illustrate the absorption of SO₂ vs. time of a hydrated lime and two activated limes.

### DETAILED DESCRIPTION OF THE INVENTION

An activated lime is produced according to the present method for use in removing acid gases from a combustion gas stream. Examples of acid gases in a combustion gas stream include sulfur trioxide, sulfur dioxide, hydrogen chloride, hydrogen fluoride, and the like.

In the present method, the calcium hydroxide (hydrated lime) is contacted with a hot gas stream at a temperature of between 750-950° F., which gas stream may comprise a combustion gas stream or air.

The calcium hydroxide may be treated to produce an activated lime at any source thereof, for example, from hydration of lime at a lime production facility, and collected and then shipped for use at a site for removal of acid gases from a combustion gas stream. Or, the calcium hydroxide may be treated to produce an activated lime at a proposed use site, such as at a power plant where acid gases are to be removed from flue gas.

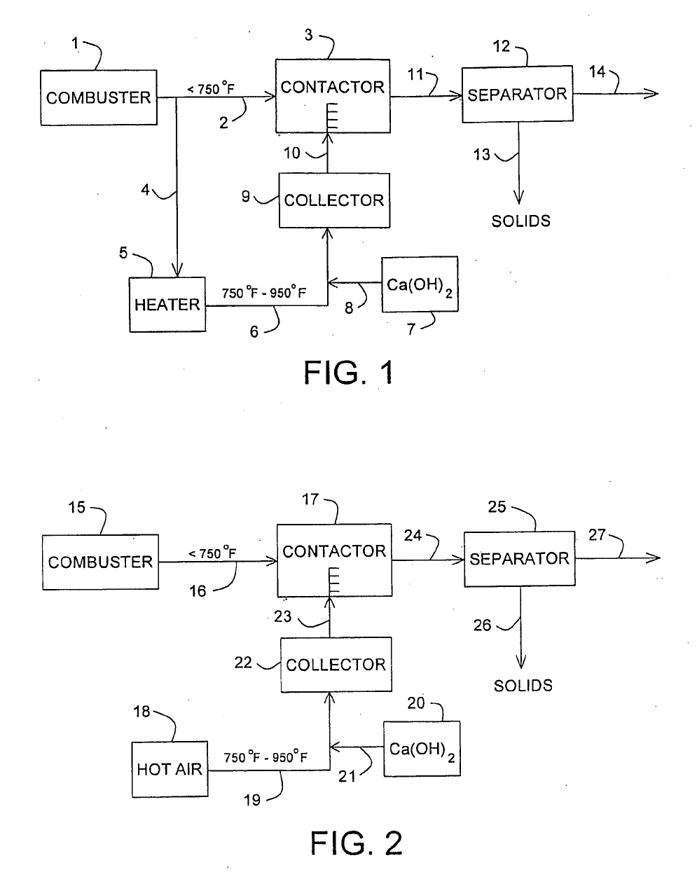

FIG. 1 illustrates an embodiment where a combustion gas stream from combuster 1 is at a temperature below about 750° F. The combustion gas stream flows through line 2 to a contactor 3. At least a portion of the combustion gas stream is diverted through line 4 to a heater 5 where the combustion gas stream is heated to a temperature between 750-950° F. and then passed through line 6. Calcium hydroxide from a source 7 is charged through line 8 to the line 6 for contact with the heated combustion gas stream. The calcium hydroxide is thermally decomposed to provide an activated time having a specific surface area of between about 30-48 square meters per gram and is collected in collector 9. The activated lime is charged from collector 9 through line 10 to the contactor 3 where it reacts with and removes acid gases from the combustion gas stream fed through line 2. The contactor 3 may be a separate unit into which the line 2 feeds or may be a portion of the contactor line 2. After contact, the clean gas stream is passed through line 11 to a separator 12, such as an electrostatic precipitator, and solids are removed therefrom through line 13, while the combustion gas stream, with acid gases removed therefrom, is discharged through line 14.

While the initial temperature of the gaseous stream may be in excess of 950° F. upon introduction of the hydrated lime, the endothermic reaction of decomposition should decrease the temperature to the range of 750-950° F. for a sufficient contact time to provide the specific surface area of 30-48 square meters per gram (preferably 36-48) of the activated lime produced. The particular initial temperature of the gaseous stream may vary dependent upon the volume of the gas stream that will absorb the endothermic reaction while providing sufficient contact time of the hydrated lime and gaseous stream to provide the specific surface area desired.

In the preferred embodiment illustrated in FIG. 2, hot air is used to heat and decompose the calcium hydroxide. As illustrated, a combustion gas stream from combustor 15, at a temperature below about 750° F. flows through line 16 to a contactor 17. Hot air, at a temperature of between 750-950° F., from a source 18, is passed through line 19. Calcium hydroxide from a source 20 is charged through line 21 to the line 19 for contact with the heated air stream. The calcium hydroxide is thermally decomposed to provide an activated lime having a specific surface area of between 30-48 square meters per gram and is collected in collector 22. The activated lime is charged from collector 22 through line 23 to the contactor 17 where it reacts with acid gases from the combustion gas stream fed through line 16. After contact, the clean gas stream is passed through line 24 to a separator 25, such as an electrostatic precipitator, and solids are removed therefrom through line 26, while the combustion gas stream, with acid gases removed therefrom, is discharged through line 27.

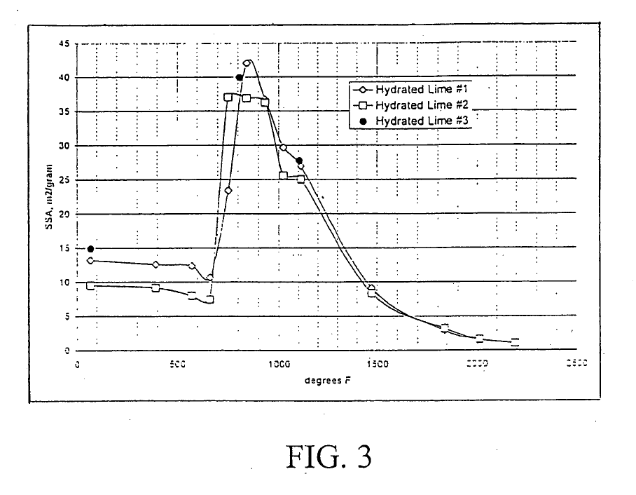

FIG. 3 shows the number of active absorption sites (as specific surface area, square meters per gram) vs. temperature for thermal decomposition to lime in air of three different hydrated limes. The data clearly shows that the specific surface area increases sharply at about 750° F. and declines rapidly at temperatures above about 950° F.

### Example I

Laboratory acid gas absorption tests were conducted with hydrated lime and activated lime to compare their capacities and rates of acid gas absorption. To prepare activated lime for the test, a portion of hydrated lime was heated to 887° F. in a laboratory muffle furnace for four hours. After the activated lime was prepared, it and a sample of the hydrated lime were each analyzed for specific surface area (nitrogen absorption using Brunauer, Emmett and Teller model) and pore volume (Barett, Joyner and Halenda model) using a Micrometrics Tri Star 3000 Surface area and porosity analyzer. The larger these values, the more effective the material is expected to be for absorption of acid gases. The data in Table 1 shows that activation increased the specific surface area and pore volume compared with hydrated lime. Activation increased the specific surface area from 19.7 to 32 square meters per gram and increased the pore volume from 0.092 to 0.153 cubic centimeters per gram. The samples were also analyzed for sulfur content prior to the absorption tests as shown in Table 2.

Samples of the hydrated lime and activated lime were each prepared for use in the absorption test by first compressing a sample to form a thin disk. The disk was broken into pieces to pass a screen with 1 millimeter openings. The material that passed the 1 millimeter screen was sieved on a screen with 0.5 millimeter openings. The material that remained on the 0.5 millimeter screen was used in the absorption test. Samples prepared in this way formed a porous bed after being placed in the absorption apparatus which allowed flue gas to flow uniformly through the sample during the test.

Laboratory absorption tests were then carried out. A 10 gram sample of hydrated lime or activated lime (originally 30.3% but subsequently absorbing water to 56.1% CaOH₂) prepared as described above was placed in an absorption chamber. The absorption chamber is a glass cylinder with a porous glass plate that supported the sample and with ports to allow flue gas to flow through the chamber. The absorption chamber containing the sample was placed in an oven maintained at 185° F. The absorption chamber was connected to a source of flue gas containing 1700 parts by volume per million of sulfur dioxide (SO₂). The flue gas containing SO₂ was generated by metering gaseous SO₂ into a stream of flue gas formed from combustion of natural gas. The flue gas containing SO₂ was maintained at 185° F. and at the start of each test was metered into the absorption chamber at a flow rate of 12 liters per minute. Flue gas, partially depleted of SO₂, that exited the absorption chamber passed through a pump and then through a moisture trap immersed in an ice bath. The flue gas was then passed through a Western Research Model 721 AT continuous SO₂ analyzer which indicated the SO₂ concentration in parts per million by volume. Prior to the beginning of each test, the flue gas containing SO₂ was directed through a bypass around the absorption chamber to allow the metering rate of SO₂ to be adjusted to yield a fixed SO₂ concentration reading on the SO₂ analyzer of 1700 parts per million by volume. The accuracy of the analyzer was checked prior to each test using calibration gas containing 1716 parts SO₂ per million by volume.

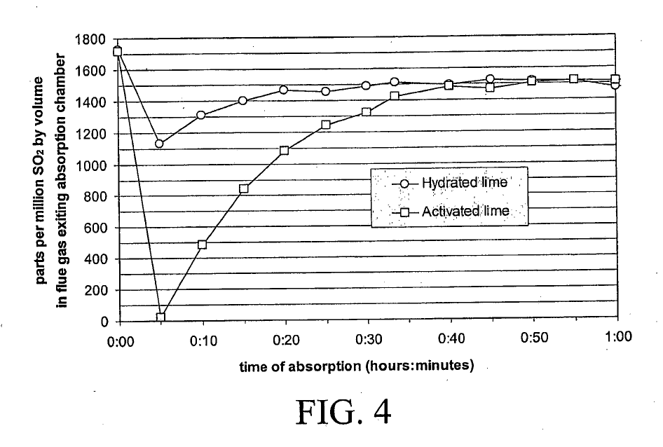

At the beginning of each test, a valve immediately ahead of the absorption chamber was opened, the bypass valve was closed, and the flue gas containing SO₂ was directed to the absorption chamber. The metering rates of flue gas and SO₂ were held constant so that the concentration of SO₂ in the flue gas entering the absorption chamber remained at about 1700 parts per million by volume for the duration of the test. SO₂ was absorbed by the sample, which caused the SO₂ analyze readings to drop below 1700 parts per million. SO₂ analyzer readings were taken at 5 minute intervals as shown in FIG. 4. Flue gas was allowed to flow through the sample in the absorption chamber for approximately 2 hours and 30 minutes. The sample was then removed from the absorption chamber and analyzed for sulfur content as shown in Table 2.

TABLE 1

| | BET Specific | BJH Cumulative | |
|---|---|---|---|
| | Surface Area | Pore Volume | Wt. % |
| Sample | (m²/g) | (cm³/g) | Ca(OH)₂ |
| Hydrated lime | 19.7 | 0.092 | 85.1 |
| Activated lime 1 | 32.0 | 0.153 | 56.1 |

TABLE 2

| | Weight | Weight | Increase | |
|---|---|---|---|---|
| | percent sulfur | percent sulfur | in weight | Relative absorption |
| | in sample | in sample | percent | of sulfur compared |
| Sample | before test | after test | sulfur | with hydrated lime |
| Hydrated lime | 0.05 | 2.66 | 2.61 | 1 |
| Activated lime 1 | 0.05 | 4.29 | 4.24 | 1.60 |

The results in Table 2 and FIG. 4 show that activated lime has a greater capacity for absorption of acid gas then hydrated lime and also absorbs acid gas at a faster rate. Table 2 shows that at the end of each test, the activated lime absorbed about 60% more SO₂ than the hydrated lime. FIG. 4 shows the SO₂ concentration in flue gas after it had passed though the sample at various times during the laboratory absorption tests. After 5 minutes of absorption, the activated lime had absorbed almost all of the SO₂, while the hydrated lime absorbed only one-third of the SO₂. Moreover, the activated lime continued to absorb more SO₂ than the hydrated lime during the first 30 minutes of the test.

This improvement in acid gas absorption capacity and rate in the laboratory tests shows that activated lime would be a better reagent for capture of acid gases, including sulfur dioxide and sulfur trioxide, in coal-fired power plants. Preferred locations for injection into the power plant flue gas include immediately after the furnace, ahead of a selective catalytic reduction unit, or ahead of an air preheater. Flue gas temperature at these locations is about 650-750° F. Other preferred injection locations include ahead of an ESP or ahead of or immediately after fans ahead a wet flue gas desulfurization unit. An additional location is ahead of a gas-gas heat exchanger which is used to heat flue gas exiting a wet desulfurization unit prior to discharge to the atmosphere. Flue gas temperature at these locations is about 300-350° F.

### Example II

A second laboratory acid gas absorption test was conducted with activated lime prepared from a different sample of hydrated lime than was used in Example I. To prepare activated lime for this test, a portion of the different hydrated lime was heated to 850° F. in a laboratory muffle furnace for sixteen hours. After the activated lime was prepared, it was analyzed for BET specific surface area and BJH pore volume as in Example I. The data in Table 3 shows that activation increased the BET specific surface area to 43.7 square meters per gram and increased the BJH pore volume to almost 0.21 cubic centimeters per gram. The activated lime was analyzed for sulfur content prior to the absorption test as shown in Table 4. A 10 gram sample of activated lime for use in the absorption test was prepared as described in Example I.

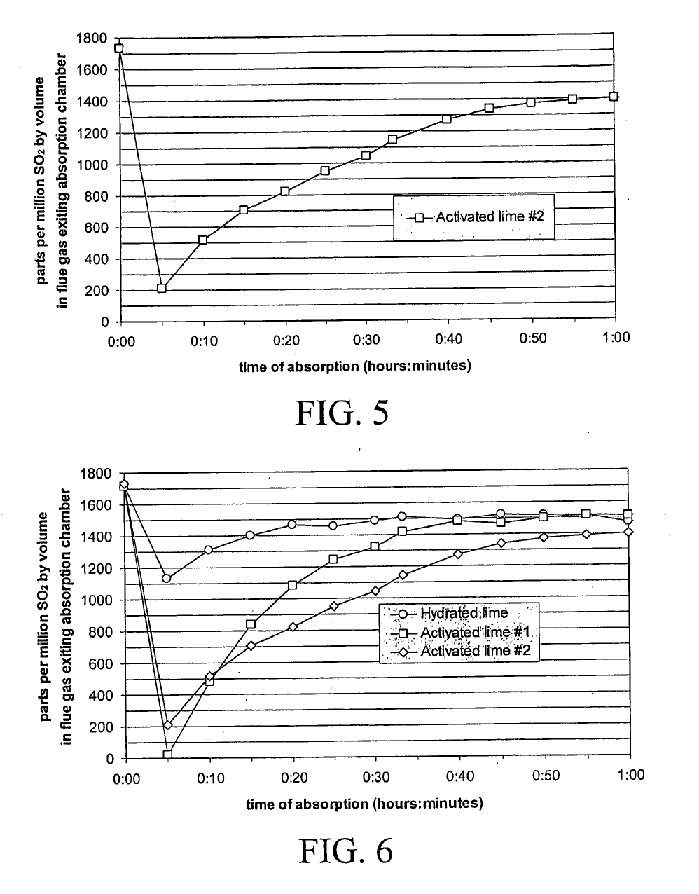

The laboratory absorption test was carried out as described for Example I. SO₂ analyzer readings were taken at 5 minute intervals as shown in FIG. 5. At the end of the absorption test, the sample was removed from the absorption chamber and analyzed for sulfur content as shown in Table 4.

The results in Table 4 show that the activated lime in this example absorbed about 67% more SO₂ than the hydrated lime in Example I. The results in FIG. 5 show that after 5 minutes of the absorption test, the activated lime had absorbed about 87% of the SO₂ while the hydrated lime in Example I absorbed only about one-third of the SO₂.

TABLE 3

| | BET Specific | BJH Cumulative | |
|---|---|---|---|
| | Surface Area | Pore Volume | Wt. % |
| Sample | (m²/g) | (cm³/g) | Ca(OH)₂ |
| Activated lime 2 | 43.7 | 0.209 | 33.4 |

TABLE 4

| | Weight | Weight | Increase | Relative absorption |
|---|---|---|---|---|
| | percent sulfur | percent sulfur | in weight | of sulfur compared |
| | in sample | in sample | percent | with hydrated lime |
| Sample | before test | after test | sulfur | in Example 1 |
| Activated lime 2 | 0.05 | 4.42 | 4.37 | 1.67 |

FIG. 6 shows the SO₂ concentrations readings at 5 minute intervals for the hydrated lime and activated lime of Example I and the activated lime of Example II. The SO₂ absorption rate of activated lime in Example II was much faster than the hydrated lime and somewhat faster than the activated lime in Example I. The higher absorption rate for activated lime #2 over activated lime #1 is due to its higher BET specific surface area and BJH pore volume.

What is claimed is:

1. A method of forming an activated lime for the removal of acid gases from a combustion gas stream comprising;
thermally decomposing calcium hydroxide to produce calcium oxide by contacting the calcium hydroxide with a gaseous stream having a temperature of between 750-950° F. for a sufficient time to produce a calcium oxide having a specific surface area of between about 30-48 square meters per gram; and
collecting the calcium oxide so produced for use in contact with a combustion gas stream to remove acid gases therefrom.

2. The method of forming an activated lime for removal of acid gases from a combustion gas stream as defined in claim 1 wherein said temperature is between about 750-850° F.

3. The method of forming an activated lime for removal of acid gases from a combustion gas stream as defined in claim 1 wherein said gaseous stream is a combustion gas stream.

4. The method of forming an activated lime for removal of acid gases from a combustion gas stream as defined in claim 1 wherein said gaseous stream is air.

5. The method of forming an activated lime for the removal of acid gases from a combustion gas stream as defined in claim 1 when the specific surface area is between 36-48 square meters per gram.

6. A method of forming an activated lime for the removal of acid gases from a combustion gas stream comprising;
thermally decomposing calcium hydroxide to produce calcium oxide by contacting the calcium hydroxide with hot air having a temperature of between 750-950° F. for a sufficient time to produce a calcium oxide having a specific surface area of between about 30-48 square meters per gram; and
collecting the calcium oxide so produced for use in contact with a combustion gas stream to remove acid gases therefrom.

7. The method of forming an activated lime for removal of acid gases from a combustion gas stream as defined in claim 6 wherein said temperature is between about 750-850° F.

8. The method of forming an activated lime for the removal of acid gases from a combustion gas stream as defined in claim 6 when the specific surface area is between 36-48 square meters per gram.
